(19) United States
(12) Patent Application Publication
(10) Pub. No.: US 2025/0138738 A1
(43) Pub. Date: May 1, 2025

(54) MEMORY SYSTEM, OPERATION METHOD THEREOF, AND COMPUTER READABLE STORAGE MEDIUM

(71) Applicant: YANGTZE MEMORY TECHNOLOGIES CO., LTD., Wuhan (CN)

(72) Inventor: Tao ZHANG, Wuhan (CN)

(21) Appl. No.: 18/424,095

(22) Filed: Jan. 26, 2024

(30) Foreign Application Priority Data
Oct. 26, 2023 (CN) 2023114067006

(51) Int. Cl. G06F 3/06; G06F 12/02

(52) U.S. Cl. CPC G06F 3/064; G06F 3/0652; G06F 3/0679; G06F 3/0604; G06F 12/0253

(57) ABSTRACT

Examples of the present disclosure discloses a memory system, an operation method thereof, and a computer readable storage medium. The memory system includes: a memory, wherein a physical space of the memory is divided into a user space and a hidden space; and a memory controller coupled with the memory and configured to: set a first block of the user space as a write booster buffer, wherein the first block is of a first level cell mode, and the write booster buffer is configured to buffer data; and set a free block of the hidden space as the write booster buffer, wherein the free block is of the first level cell mode.

### CROSS-REFERENCE TO RELATED APPLICATIONS

The present application claims priority to Chinese Patent Application No. 2023114067006, which was filed Oct. 26, 2023, is titled “MEMORY SYSTEM AND ITS OPERATING METHOD, COMPUTER-READABLE STORAGE MEDIUM,” and is hereby incorporated herein by reference in its entirety.

### TECHNICAL FIELD

Examples of the present disclosure relate to the field of semiconductors, and relate to, but are not limited to, a memory system, an operation method thereof, and a computer readable storage medium.

### BACKGROUND

A memory controller and a memory may be integrated into various types of storage apparatuses, e.g., a Solid State Drive (SSD), a Universal Flash Storage (UFS), an embedded Multi-Media Card (eMMC), etc. The memory controller may control operations of the memory, e.g., read, write, or erase operations, etc.

### SUMMARY

The present disclosure provides a memory system, an operation method thereof, and a computer readable storage medium.

According to a first aspect of examples of the present disclosure, a memory system is provided, which comprises: a memory, wherein a physical space of the memory is divided into a user space and a hidden space; and a memory controller coupled with the memory and configured to: set a first block of the user space as a write booster buffer, wherein the first block is of a first level cell mode, and the write booster buffer is configured to buffer data; and set a free block of the hidden space as the write booster buffer, wherein the free block is of the first level cell mode.

In some examples, the hidden space comprises an over provisioning subspace configured for garbage collection; the memory controller is configured to: set a free block of the over provisioning subspace as the write booster buffer.

In some examples, the memory controller is further configured to: when the hidden space requires use of the free block of the over provisioning subspace, return the free block occupied by the write booster buffer to the over provisioning subspace.

In some examples, the memory controller is configured to: write data buffered in the free block occupied by the write booster buffer to a second block of the user space, wherein the second block is of a second level cell mode, and the number of bits stored in a memory cell of the second level cell mode is greater than the number of bits stored in a memory cell of the first level cell mode; and after writing the data buffered in the free block to the second block, erase the free block so that the free block is returned to the over provisioning subspace.

In some examples, scenarios where the hidden space requires the use of the free block of the over provisioning subspace comprise at least one of the following: an available capacity of the hidden space being less than or equal to a preset capacity, and garbage collection.

In some examples, the memory controller is further configured to: when an erase count of the free block of the hidden space is greater than or equal to a preset value, stop setting the free block of the hidden space as the write booster buffer.

In some examples, the memory controller is further configured to: when an erase count of the free block of the hidden space is greater than or equal to a preset value, buffer data to be buffered to the free block to the first block.

In some examples, the memory controller is configured to: exchange a physical address of the free block and a physical address of the first block.

In some examples, the memory controller is further configured to: write the data buffered in the first block to a second block of the user space, wherein the second block is of a second level cell mode, and the number of bits stored in a memory cell of the second level cell mode is greater than the number of bits stored in a memory cell of the first level cell mode; and after writing the data buffered in the first block to the second block, erase the first block.

In some examples, the memory controller is further configured to: set the first block of the user space to the first level cell mode; set a block of the hidden space to the first level cell mode; and set a second block of the user space to a second level cell mode, wherein the second block is configured to store the data.

In some examples, the memory system comprises: a solid state drive, an embedded multi-media card, and a universal flash storage.

According to a second aspect of examples of the present disclosure, an operation method of a memory system is provided, wherein the memory system comprises a memory and a memory controller coupled with the memory, and a physical space of the memory is divided into a user space and a hidden space; wherein the operation method comprises: setting a first block of the user space as a write booster buffer, wherein the first block is of a first level cell mode, and the write booster buffer is configured to buffer data; and setting a free block of the hidden space as the write booster buffer, wherein the free block is of the first level cell mode.

In some examples, the hidden space comprises an over provisioning subspace configured for garbage collection; setting the free block of the hidden space as the write booster buffer comprises: setting a free block of the over provisioning subspace as the write booster buffer.

In some examples, the operation method further comprises: when the hidden space requires use of the free block of the over provisioning subspace, returning the free block occupied by the write booster buffer to the over provisioning subspace.

In some examples, returning the free block occupied by the write booster buffer to the over provisioning subspace comprises: writing data buffered in the free block occupied by the write booster buffer to a second block of the user space, wherein the second block is of a second level cell mode, and the number of bits stored in a memory cell of the second level cell mode is greater than the number of bits stored in a memory cell of the first level cell mode; and after writing the data buffered in the free block to the second block, erasing the free block so that the free block is returned to the over provisioning subspace.

In some examples, the operation method further comprises: when an erase count of the free block of the hidden space is greater than or equal to a preset value, stopping setting the free block of the hidden space as the write booster buffer.

In some examples, the operation method further comprises: when an erase count of the free block of the hidden space is greater than or equal to a preset value, buffering data to be buffered to the free block to the first block.

In some examples, buffering the data to be buffered to the free block to the first block comprises: exchanging a physical address of the free block and a physical address of the first block.

In some examples, the operation method further comprises: setting the first block of the user space to the first level cell mode; setting a block of the hidden space to the first level cell mode; and setting a second block of the user space to a second level cell mode, wherein the second block is configured to store the data.

According to a third aspect of examples of the present disclosure, a computer readable storage medium is provided, having instructions stored thereon that, when executed, implement the operation method of any one of the examples in the second aspect of the present disclosure.

In the examples of the present disclosure, a write speed may be increased by setting the first block of the user space as the write booster buffer; and a capacity of the write booster buffer may be increased by setting the free block of the hidden space as the write booster buffer. Even in a dirty scenario, the write booster buffer still can use the free block of the hidden space, which is favorable to the improvement of write performance in the dirty scenario.

### BRIEF DESCRIPTION OF THE DRAWINGS

In the drawings, unless otherwise stated, same reference numerals denote same or like components or elements throughout a plurality of drawings. These drawings are not necessarily drawn to scale. It is to be understood that the drawings depict only some implementations disclosed in the present application, which are not to be considered as limitations on the scope of the present application.

FIG. 1 is a schematic diagram illustrating a system according to examples of the present disclosure.

FIG. 2A is a schematic diagram illustrating a memory card according to examples of the present disclosure.

FIG. 2B is a schematic diagram illustrating a solid state drive according to examples of the present disclosure.

FIG. 3 is a schematic diagram one illustrating a physical space of a memory according to examples of the present disclosure.

FIG. 4 is a schematic diagram two illustrating a physical space of a memory according to examples of the present disclosure.

FIG. 5 is a flow diagram illustrating an operation method of a memory system according to examples of the present disclosure.

### DETAILED DESCRIPTION

For ease of understanding of the present disclosure, example implementations of the present disclosure will be described below in more detail with reference to the relevant drawings. Although the example implementations of the present disclosure are shown in the drawings, it is to be understood that the present disclosure may be achieved in various forms which should not be limited by example implementations as set forth herein. Rather, these implementations are provided for a more thorough understanding of the present disclosure, and can fully convey the scope of the present disclosure to those skilled in the art.

In the following description, numerous specific details are presented to provide a more thorough understanding of the present disclosure. However, it is apparent to those skilled in the art that the present disclosure may be implemented without one or more of these details. In some examples, in order to avoid confusing with the present disclosure, some technical features well-known in the art are not described; that is, not all features of actual examples are described herein, and well-known functions and structures are not described in detail.

In general, terminologies may be understood at least in part from usage in the context. For example, the term “one or more” as used herein, depending at least in part upon the context, can be used to describe any feature, structure, or characteristic in a singular sense or can be used to describe combinations of features, structures, or characteristics in a plural sense. Similarly, terms, such as “a” or “the” again, can be understood to convey a singular usage or to convey a plural usage, depending at least in part upon the context. In addition, the term “based on” may be understood as being not necessarily intended to convey an exclusive set of factors and may, instead, allow for existence of additional factors not necessarily expressly described, again, depending at least in part upon the context.

The terms as used herein are only intended to describe the examples, and are not used as limitations of the present disclosure, unless otherwise defined. As used herein, unless otherwise indicated expressly in the context, “a”, “one” and “the” in a singular form are also intended to comprise a plural form. It is also to be understood that the terms “consist of” and/or “comprise”, when used in this specification, determine the presence of a feature, integer, step, operation, element and/or component, but do not preclude the presence or addition of one or more of other features, integers, steps, operations, elements, components, and/or groups. As used herein, the term “and/or” comprises any and all combinations of the listed relevant items.

In order to understand the present disclosure, operations and structures will be provided in the following description to set forth the examples of the present disclosure. The detailed descriptions of the examples of the present disclosure are as follows. However, the present disclosure may also have other implementations in addition to these detailed descriptions.

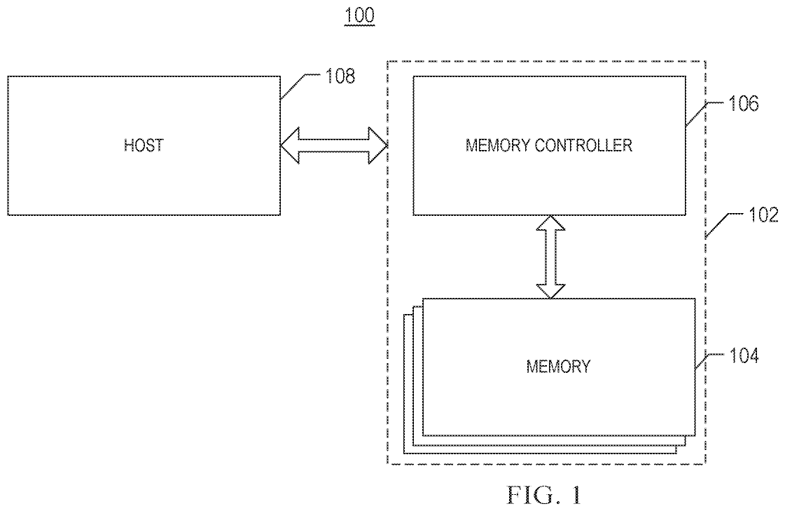

FIG. 1 is a schematic diagram illustrating a system 100 according to examples of the present disclosure. The system 100 may be a mobile phone, a desktop computer, a laptop computer, a tablet computer, a vehicle computer, a game console, a printer, a pointing apparatus, a wearable electronic apparatus, a smart sensor, a Virtual Reality (VR) apparatus, an Augmented Reality (AR) apparatus or any other suitable electronic apparatuses having storages therein. As shown in FIG. 1, the system 100 may comprise a host 108 and a memory system 102, wherein the memory system 102 has one or more memories 104 and a memory controller 106. The host 108 may be a processor (e.g., a Central Processing Unit (CPU)) or a System on Chip (SOC) (such as an Application Processor (AP)) of an electronic apparatus. The host 108 may be configured to send or receive data to or from the memories 104.

The memory controller 106 is coupled to the memories 104 and the host 108, and configured to control the memories 104. The memory controller 106 can manage data stored in the memories 104 and communicate with the host 108. In some implementations, the memory controller 106 is designed for operating in a low duty-cycle environment, e.g., a Secure Digital Memory Card (SD Card), a Compact Flash Card (CF Card), a Universal Serial Bus (USB) flash drive, or other media for use in electronic apparatuses, such as a personal computer, a digital camera, and a mobile phone, etc. In some implementations, the memory controller 106 is designed for operating in a high duty-cycle environment, e.g., a Solid State Disk (SSD) or an Embedded Multi Media Card (eMMC) which is used as a data storage for a mobile apparatus, such as a smartphone, a tablet computer, and a laptop computer, etc., and an enterprise memory array.

The memory controller 106 can be configured to control operations of the memories 104, such as read, write, and erase operations. The memory controller 106 may be further configured to manage various functions with respect to data stored or to be stored in the memories 104, including, but not limited to, bad-block management, garbage collection, logical-to-physical address translation, and wear leveling, etc. In some implementations, the memory controller 106 is further configured to process an Error Correction Code (ECC) with respect to data read from or written to the memories 104. The memory controller 106 may also perform any other suitable functions, such as formatting the memories 104. The memory controller 106 may communicate with a host (e.g., the host 108) according to an example communication protocol. For example, the memory controller 106 may communicate with the host through at least one of various interface protocols, such as a USB protocol, an MMC protocol, a Peripheral Component Interconnect (PCI) protocol, a Peripheral Component Interconnect Express (PCIE) protocol, an Advanced Technology Attachment (ATA) protocol, a serial ATA protocol, a parallel ATA protocol, a Small Computer System Interface (SCSI) protocol, an Enhanced System Drive Interface (ESDI) protocol, an Integrated Drive Electronics (IDE) protocol, and a Firewire protocol, etc.

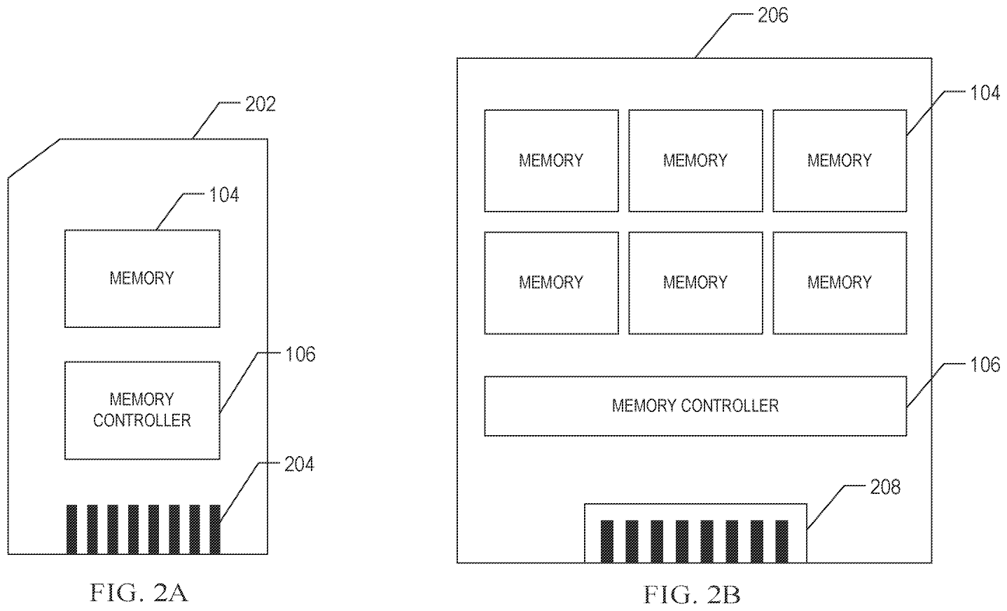

The memory controller 106 and the one or more memories 104 can be integrated into various types of storage apparatuses, for example, be included in the same package (e.g., a universal flash storage package or an eMMC package). For example, the memory system 102 can be implemented and packaged into different types of end electronic products. In one example, as shown in FIG. 2A, the memory controller 106 and a single memory 104 may be integrated into a memory card 202. The memory card 202 may include a Personal Computer Memory Card International Association (PCMCIA) card, a CF card, a Smart Media (SM) card, a memory stick, a Multi Media Card (MMC), a Reduced-Size MMC (RS-MMC), a Multi Media Card Micro (MMCmicro) card, an SD card (SD, miniSD, microSD, and SDHC), and a Universal Flash Storage (UFS), etc. The memory card 202 may further comprise a memory card connector 204 that couples the memory card 202 with a host (e.g., the host 108 in FIG. 1). In another example, as shown in FIG. 2B, the memory controller 106 and a plurality of memory devices 104 may be integrated into an SSD 206. The SSD 206 may further comprise an SSD connector 208 that couples the SSD 206 with a host (e.g., the host 108 in FIG. 1). In some implementations, a storage capacity and/or an operation speed of the SSD 206 are greater than a storage capacity and/or an operation speed of the memory card 202. The memory 104 may include volatile and non-volatile memories, such as a NAND flash memory, a dynamic random access memory, a ferroelectric random memory, a magnetic random access memory, a phase change random access memory, a resistive random access memory, and a nano random access memory, etc.

FIG. 3 is a schematic diagram one illustrating a physical space of a memory 300 according to examples of the present disclosure. Referring to FIG. 3, a physical space of the memory 300 may be divided into a user space 310 and a hidden space 320, wherein the user space 310 is configured to store data, and the hidden space 320 is configured to store parameter information or state information, etc. of the user space 310. The user space 310 and the hidden space 320 are each required to reserve a certain number of blocks for performing a garbage collection operation, and a space constituted by the reserved blocks is referred to as an over provisioning (OP) subspace, e.g., an over provisioning subspace 311 of the user space 310 and an over provisioning subspace 321 of the hidden space 320 shown in FIG. 3. Here, there may be one or more blocks in the over provisioning subspace, and the present disclosure has no limitations thereto. In practical application, a capacity of the over provisioning subspace is generally determined from calculation and cannot be changed arbitrarily, e.g., reducing a capacity of the over provisioning subspace 321 of the hidden space 320 to increase a capacity of the over provisioning subspace 311 of the user space 310, etc.

In order to improve write performance of a storage apparatus, part of blocks of the user space 310 may be set as a write booster buffer 330, e.g., configuring memory cells of the part of the blocks of the user space 310 to be in a single-level cell mode and to buffer data. A capacity of the write booster buffer 330 is closely related to the write performance, and a product of a manufacturer that can provide a larger capacity of the write booster buffer 330 undoubtedly has more competitiveness in the whole market.

However, the capacity of the write booster buffer 330 is limited by a capacity of the user space 310, and the capacity of the write booster buffer 330 decreases as the available capacity of the user space 310 decreases. In an implementation, the capacity of the write booster buffer 330 originates from the user space 310, and in order to prevent the write booster buffer 330 from consuming the blocks of the SLC mode excessively fast, a threshold line is typically disposed, as shown by a dashed line in FIG. 3. When the write booster buffer 330 is in a dirty scenario, for example, after available blocks of the write booster buffer 330 decreases to the threshold line, the capacity of the write booster buffer 330 becomes zero, and blocks to be used subsequently are in a multi-level cell mode, such as a triple-level cell mode. At this time, a write speed is reduced significantly, and the write performance is degraded. Therefore, improvements may be made to increase the capacity of the write booster buffer so as to improve the write performance.

On that basis, examples of the present disclosure provide a memory system.

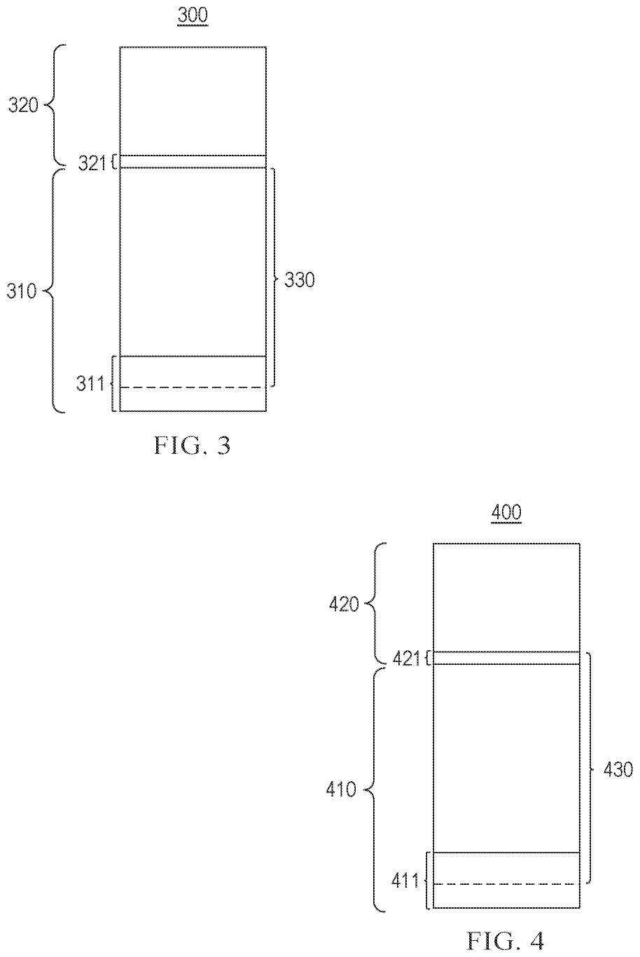

FIG. 4 is a schematic diagram illustrating a physical space of a memory 400 according to examples of the present disclosure. The memory system provided by the examples of the present disclosure is described below in conjunction with FIG. 4. With reference to FIG. 4, the memory system comprises: a memory 400, wherein a physical space of the memory 400 is divided into a user space 410 and a hidden space 420; and a memory controller coupled with the memory 400 and configured to: set a first block of the user space 410 as a write booster buffer 430, wherein the first block is of a first level cell mode, and the write booster buffer 430 is configured to buffer data; and set a free block of the hidden space 420 as the write booster buffer 430, wherein the free block is of the first level cell mode.

The memory system comprises: a solid state drive, a universal flash storage, and an embedded multi-media card, etc. Here, an example structure and composition of the memory system may be referred to the above detailed description of FIGS. 1, 2A, and 2B, and the other details regarding the memory system are similar to those described above, which are no longer repeated here for conciseness.

The memory 400 includes an SLC memory, a Multi-Level Cell (MLC) memory, a Trinary-Level Cell (TLC) memory, or a Quad-Level Cell (QLC) memory, etc., wherein one memory cell of the SLC memory stores one bit, one memory cell of the MLC memory stores two bits, one memory cell of the TLC memory stores three bits, and one memory cell of the QLC memory stores four bits. For ease of understanding, the TLC memory is taken as an example for description in the present disclosure.

The memory 400 comprises a plurality of blocks, each block comprises a plurality of memory pages, and each memory page comprises a plurality of memory cells. Taking a NAND memory as an example, a minimum unit of performing an erase operation by the NAND memory is a block, and a minimum unit of performing a write operation by the NAND memory is a memory page. In practical application, the plurality of blocks of the memory may be partitioned. In an implementation, the physical space corresponding to the plurality of blocks may be divided into the user space 410 and the hidden space 420, wherein the user space 410 is configured to store data, and the hidden space 420 is configured to store parameter information or state information, etc. of the user space 410.

The memory controller is coupled with the memory 400 and may control the memory 400. In an implementation, the memory controller may comprise a processor configured to control overall operations of the memory controller. The processor may drive firmware to control the overall operations of the memory controller, so as to implement various functions of the memory controller, such as bad block management, garbage collection, logical-to-physical address translation, wear leveling, and data error correction, etc. The processor may also manage and maintain the plurality of blocks in the memory 400. For example, the firmware manages the free block through an array or a block bitmap, etc. In this example, the firmware may be stored in the memory controller or the memory, and when the firmware is stored in the memory, the firmware may be loaded into the memory controller when powered on.

The memory controller sets the first block of the user space 410 as the write booster buffer 430 and sets the free block of the hidden space 420 as the write booster buffer 430, wherein the first block and the free block are both of the first level cell mode. As such, the capacity of the write booster buffer 430 can be increased. Here, the first level cell mode includes an SLC mode, an MLC mode, or a TLC mode, etc. In an example, when the memory 400 is a TLC memory, the first level cell mode may be the SLC mode or the MLC mode. In this example, at least part of first blocks of the over provisioning subspace 411 of the user space 410 may be set as the write booster buffer 430.

It is to be noted that the first block and the free block may be set as the write booster buffer 430 at the same time or successively, and the present disclosure has no limitations thereto. There may be one or more free blocks in the hidden space 420 set as the write booster buffer 430. In practical application, the number of the free blocks set as the write booster buffer 430 may be adjusted dynamically according to a current capacity of the write booster buffer 430 and/or an amount of data to be written currently to the user space 410.

In an example, the first level cell mode is the SLC mode, and the write booster buffer 430 is an SLC buffer configured to temporarily or permanently buffer data. By setting the part of the blocks of the memory as the SLC buffer, a write request may be processed with a small latency, the write speed is increased, and the overall write performance is improved. In practical application, the data buffered in the SLC buffer may be flushed to a data memory region in the user space, e.g., other space in the user space than the write booster buffer 430, either through a command of the host or when the firmware is free.

In the examples of the present disclosure, a write speed may be increased by setting the first block of the user space as the write booster buffer; and a capacity of the write booster buffer may be increased by setting the free block of the hidden space as the write booster buffer. Even in a dirty scenario, the write booster buffer still can use the free block of the hidden space, which is favorable to the improvement of write performance in the dirty scenario.

In some examples, the processor may comprise a partitioning module having functions such as partition creation, partition deletion, partition merging, and partition expansion, etc. Through a combination of the relevant functions of the partitioning module, the plurality of blocks of the memory 400 can be partitioned. It is to be noted that the processor may further comprise other functional modules known in the field. The various modules of the processor may be software modules running on a processor (e.g., a Microcontroller Unit (MCU)) that is part of the processor, or may be hardware modules (such as an Integrated Circuit (IC, e.g., an Application-Specific IC (ASIC), and a Field Programmable Gate Array (FPGA), etc.)) of a Finite State Machine (FSM), or may be combinations of software modules and hardware modules.

In some examples, the hidden space 420 comprises an over provisioning subspace 421 configured for garbage collection; and the memory controller is configured to: set a free block of the over provisioning subspace 421 as the write booster buffer 430.

In an example, when the capacity of the write booster buffer 430 is small or an available capacity is insufficient, the free block of the over provisioning subspace 421 may be set as the write booster buffer 430. For example, part of the free blocks are divided from the over provisioning subspace 421 and count as the scope of the write booster buffer 430, thereby increasing the capacity of the write booster buffer 430. It is to be noted that the free block divided out and counting as the write booster buffer 430 still belong to the hidden space 420.

In other examples, when there are an unoccupied free block in other space than the over provisioning subspace 421 in the hidden space 420, part of the free blocks in the space may be set as the write booster buffer 430, and the present disclosure has no limitations thereto.

In some examples, the memory controller is further configured to: when the hidden space 420 requires use of the free block of the over provisioning subspace 421, return the free block occupied by the write booster buffer 430 to the over provisioning subspace 421. Here, scenarios where the hidden space 420 requires the use of the free block of the over provisioning subspace 421 comprise at least one of the following: an available capacity of the hidden space 420 being less than or equal to a preset capacity, and garbage collection. It may be understood that when the hidden space 420 requires the use of the free block of the over provisioning subspace, the write booster buffer 430 is required to return the occupied free block timely.

In an example, when the available capacity of the hidden space 420 is less than or equal to the preset capacity, the free block occupied by the write booster buffer 430 may be returned to the over provisioning subspace 421 for use by the hidden space 420. Here, the preset capacity may be set reasonably according to an actual memory capacity, and the present disclosure has no limitations thereto. In an example, the preset capacity is less than the capacity of the hidden space 420.

In another example, when the hidden space 420 needs garbage collection, the free block occupied by the write booster buffer 430 may be returned to the over provisioning subspace 421 for performing a garbage collection operation in the hidden space 420. The garbage collection operation refers to a transfer of valid data on one or more blocks to a free block and erasing the one or more blocks, so that the erased blocks are available for writing of new data.

In some examples, the memory controller is configured to: write data buffered in the free block occupied by the write booster buffer 430 to a second block of the user space 410, wherein the second block is of a second level cell mode, and the number of bits stored in a memory cell of the second level cell mode is greater than the number of bits stored in a memory cell of the first level cell mode; and after writing the data buffered in the free block to the second block, erase the free block so that the free block is returned to the over provisioning subspace 421.

In an example, the data buffered in the free block is written to the data memory region of the user space, and the free block is erased. Since the free block still belongs to the hidden space 420, the erased free block is returned to the over provisioning subspace 421 without repartitioning. In this example, the data memory region comprises one or more second blocks, and the second level cell mode comprises the MLC mode, the TLC mode, or the QLC mode, etc. When the memory 400 is a TLC memory, the second level cell mode may be the TLC mode.

In some examples, the memory controller is further configured to: when an erase count of the free block of the hidden space 420 is greater than or equal to a preset value, stop setting the free block of the hidden space 420 as the write booster buffer 430.

Since the write booster buffer 430 uses the free block of the hidden space 420, wear of the hidden space 420 may be accelerated. In order to level wear of the user space 410 and the hidden space 420 as much as possible, setting of the free block of the hidden space 420 as the write booster buffer 430 may be stopped when the erase count (EC) of the free block of the hidden space 420 is greater than or equal to the preset value. As such, the wear of the user space 410 may be ensured as being level with that of the hidden space 420. Here, those skilled in the art may reasonably set the preset value according to actual characteristics of the memory cells in the memory, and the present disclosure is not limited hereby.

In some examples, the memory controller is further configured to: when an erase count of the free block of the hidden space 420 is greater than or equal to a preset value, buffer data to be buffered to the free block to the first block. By buffering the data to be buffered to the free block to the first block, locations of blocks of the hidden space 420 and the user space 410 may be exchanged. That is, a block of the user space that stores no data is reclassified into the hidden space 420, and a free block of the hidden space 420 with much wear is reclassified into the user space 410, so as to ensure that the wear of the user space 410 is level with that of the hidden space 420.

In some examples, the memory controller is configured to: exchange a physical address of the free block and a physical address of the first block. In this example, the free block that is exchanged may be a block of the hidden space 420 with much wear, and the first block that is exchanged may be a block of the user space that stores no data. By exchanging the physical address of the free block and the physical address of the first block, locations of the free block and the first block may be exchanged.

In some examples, the memory controller is further configured to: write data buffered in the first block to a second block of the user space 410, wherein the second block is of a second level cell mode, and the number of bits stored in a memory cell of the second level cell mode is greater than the number of bits stored in a memory cell of the first level cell mode; and after writing the data buffered in the first block to the second block, erase the first block.

In an example, the data buffered in the first block is written to the data memory region of the user space, and the first block is erased, wherein locations of the erased first block and the free block of the hidden space may be exchanged. The second level cell mode includes the MLC mode, the TLC mode, or the QLC mode, etc. When the memory 400 is a TLC memory, the second level cell mode may be the TLC mode.

In some examples, the memory controller is further configured to: set the first block of the user space 410 to the first level cell mode; set a block of the hidden space 420 to the first level cell mode; and set a second block of the user space 410 to a second level cell mode, wherein the second block is configured to store the data.

In an example, the memory controller sets the first block of the user space 410 to the SLC mode, sets the second block of the user space 410 to the TLC mode, and sets the block of the hidden space 420 to the SLC mode. The first block of the user space 410 is configured to buffer the data, and one or more pieces of data buffered in the first block may be flushed into the second block of the user space 410. Part of the blocks of the hidden space 420 set to the SLC mode are configured to store parameter information or state information, etc. of the user space 410, and part of the free blocks of the hidden space 420 set to the SLC mode may dynamically count as the scope of the write booster buffer 430.

In the examples of the present disclosure, by setting the first block of the user space to the first level cell mode, the first block may be set as the write booster buffer and a write speed may be increased; and by setting the block of the hidden space to the first level cell mode, the free block of the hidden space may be set as the write booster buffer, and a capacity of the write booster buffer may be increased, thereby facilitating the improvement of write performance.

Based on the above memory system, the examples of the present disclosure further provide an operation method of a memory system.

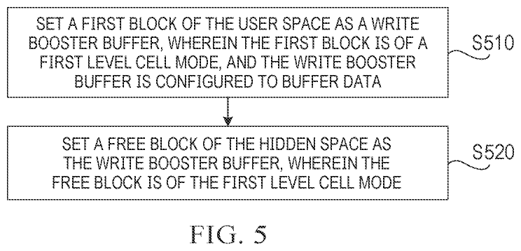

FIG. 5 is a flow diagram illustrating an operation method of a memory system according to examples of the present disclosure. The memory system comprises a memory and a memory controller coupled with the memory, and a physical space of the memory is divided into a user space and a hidden space. With reference to FIG. 5, the operation method comprises the following operations.

Operation S510: setting a first block of the user space as a write booster buffer, wherein the first block is of a first level cell mode, and the write booster buffer is configured to buffer data.

Operation S520: setting a free block of the hidden space as the write booster buffer, wherein the free block is of the first level cell mode.

In some examples, the hidden space comprises an over provisioning subspace configured for garbage collection; and above operation S520 comprises: setting a free block of the over provisioning subspace as the write booster buffer.

In some examples, the above operation method further comprises: when the hidden space requires use of the free block of the over provisioning subspace, returning the free block occupied by the write booster buffer to the over provisioning subspace.

In some examples, the above returning the free block occupied by the write booster buffer to the over provisioning subspace comprises: writing data buffered in the free block occupied by the write booster buffer to a second block of the user space, wherein the second block is of a second level cell mode, and the number of bits stored in a memory cell of the second level cell mode is greater than the number of bits stored in a memory cell of the first level cell mode; and after writing the data buffered in the free block to the second block, erasing the free block so that the free block is returned to the over provisioning subspace.

In some examples, the above operation method further comprises: when an erase count of the free block of the hidden space is greater than or equal to a preset value, stopping setting the free block of the hidden space as the write booster buffer.

In some examples, the above operation method further comprises: when an erase count of the free block of the hidden space is greater than or equal to a preset value, buffering data to be buffered to the free block to the first block.

In some examples, above buffering the data to be buffered to the free block to the first block comprises: exchanging a physical address of the free block and a physical address of the first block.

In some examples, the above operation method further comprises: setting the first block of the user space to the first level cell mode; setting a block of the hidden space to the first level cell mode; and setting a second block of the user space to a second level cell mode, wherein the second block is configured to store the data.

The above operation method is described in detail on the memory system side, which is no longer repeated here for conciseness.

The examples of the present disclosure further provide a computer readable storage medium having instructions stored thereon which, when executed, implement the operation method of any one of the above examples.

Here, all or part of the processes in the above example method may be implemented by instructing relevant hardware through a computer program. The program may be stored in a computer readable storage medium. The program when executed, may comprise the processes of the above method examples. The storage medium may be a diskette, an optical disk, a Read-Only Memory (ROM), a Random Access Memory (RAM), a Flash Memory, a Hard Disk Drive (HDD), or a solid state drive, etc.; and the storage medium may further include a combination of the above types of memories.

The examples of the present disclosure further provide an electronic apparatus, comprising: a memory system as described in any one of the above examples.

The methods disclosed in several method examples as provided by the present disclosure may be combined freely to obtain new method examples in case of no conflicts.

The characteristics disclosed in several device examples as provided by the present disclosure may be combined freely to obtain new device examples in case of no conflicts.

It is to be understood that, references to “one example” or “an example” throughout this specification mean that features, structures, or characteristics related to the examples are included in at least one example of the present disclosure. Therefore, “in one example” or “in an example” throughout this specification does not necessarily refer to the same example. Furthermore, these example features, structures, or characteristics may be incorporated in one or more examples in any suitable manner. It is to be understood that, in various examples of the present disclosure, sequence numbers of the above processes do not indicate an execution sequence, and an execution sequence of various processes shall be determined by functionalities and intrinsic logics thereof, and shall constitute no limitation on an implementation process of the examples of the present disclosure. The above sequence numbers of the examples of the present disclosure are only for description, and do not represent advantages or disadvantages of the examples.

It is to be noted that, the terms “comprise”, “include” or any variants thereof herein are intended to cover non-exclusive inclusion, such that a process, a method, an article or a device comprising a series of elements comprises not only those elements, but also other elements not listed explicitly, or elements inherent to this process, method, article or device. In case of no more limitations, an element defined by a statement “comprising one . . . ” do not preclude the presence of another identical element in the process, method, article or device comprising this element.

The above descriptions are merely implementations of the present disclosure, and the protection scope of the present disclosure is not limited thereto. Any variation or replacement that may be readily figured out by those skilled in the art within the technical scope disclosed by the present disclosure shall fall within the protection scope of the present disclosure. Therefore, the protection scope of the present disclosure shall be defined by the protection scope of the claims.

What is claimed is:

1. A memory system, comprising:
a memory, wherein a physical space of the memory is divided into a user space and a hidden space; and
a memory controller coupled with the memory and configured to:
set a first block of the user space as a write booster buffer, wherein the first block is of a first level cell mode, and the write booster buffer is configured to buffer data; and
set a free block of the hidden space as the write booster buffer, wherein the free block is of the first level cell mode.

2. The memory system of claim 1, wherein the hidden space comprises an over provisioning subspace configured for garbage collection; and
the memory controller is configured to:
set a free block of the over provisioning subspace as the write booster buffer.

3. The memory system of claim 2, wherein the memory controller is further configured to:
when the hidden space requires use of the free block of the over provisioning subspace, return the free block occupied by the write booster buffer to the over provisioning subspace.

4. The memory system of claim 3, wherein the memory controller is configured to:
write data buffered in the free block occupied by the write booster buffer to a second block of the user space, wherein the second block is of a second level cell mode, and a number of bits stored in a memory cell of the second level cell mode is greater than a number of bits stored in a memory cell of the first level cell mode; and
after writing the data buffered in the free block to the second block, erase the free block so that the free block is returned to the over provisioning subspace.

5. The memory system of claim 2, wherein scenarios where the hidden space requires the use of the free block of the over provisioning subspace comprise at least one of the following: an available capacity of the hidden space being less than or equal to a preset capacity, and garbage collection.

6. The memory system of claim 1, wherein the memory controller is further configured to:
when an erase count of the free block of the hidden space is greater than or equal to a preset value, stop setting the free block of the hidden space as the write booster buffer.

7. The memory system of claim 1, wherein the memory controller is further configured to:
when an erase count of the free block of the hidden space is greater than or equal to a preset value, buffer data to be buffered to the free block to the first block.

8. The memory system of claim 7, wherein the memory controller is configured to:
exchange a physical address of the free block and a physical address of the first block.

9. The memory system of claim 7, wherein the memory controller is further configured to:
write the data buffered in the first block to a second block of the user space, wherein the second block is of a second level cell mode, and a number of bits stored in a memory cell of the second level cell mode is greater than a number of bits stored in a memory cell of the first level cell mode; and
after writing the data buffered in the first block to the second block, erase the first block.

10. The memory system of claim 1, wherein the memory controller is further configured to:
set the first block of the user space to the first level cell mode;
set a block of the hidden space to the first level cell mode; and
set a second block of the user space to a second level cell mode, wherein the second block is configured to store the data.

11. The memory system of claim 1, wherein the memory system comprises: a solid state drive, an embedded multi-media card, and a universal flash storage.

12. An operation method of a memory system, wherein the memory system comprises a memory and a memory controller coupled with the memory, and a physical space of the memory is divided into a user space and a hidden space;
wherein the operation method comprises:
setting a first block of the user space as a write booster buffer, wherein the first block is of a first level cell mode, and the write booster buffer is configured to buffer data; and
setting a free block of the hidden space as the write booster buffer, wherein the free block is of the first level cell mode.

13. The operation method of claim 12, wherein the hidden space comprises an over provisioning subspace configured for garbage collection;
setting the free block of the hidden space as the write booster buffer comprises:
setting a free block of the over provisioning subspace as the write booster buffer.

14. The operation method of claim 13, further comprising:
when the hidden space requires use of the free block of the over provisioning subspace, returning the free block occupied by the write booster buffer to the over provisioning subspace.

15. The operation method of claim 14, wherein returning the free block occupied by the write booster buffer to the over provisioning subspace comprises:
writing data buffered in the free block occupied by the write booster buffer to a second block of the user space, wherein the second block is of a second level cell mode, and a number of bits stored in a memory cell of the second level cell mode is greater than a number of bits stored in a memory cell of the first level cell mode; and
after writing the data buffered in the free block to the second block, erasing the free block so that the free block is returned to the over provisioning subspace.

16. The operation method of claim 12, further comprising:
when an erase count of the free block of the hidden space is greater than or equal to a preset value, stopping setting the free block of the hidden space as the write booster buffer.

17. The operation method of claim 12, further comprising:
when an erase count of the free block of the hidden space is greater than or equal to a preset value, buffering data to be buffered to the free block to the first block.

18. The operation method of claim 17, wherein buffering the data to be buffered to the free block to the first block comprises:
exchanging a physical address of the free block and a physical address of the first block.

19. The operation method of claim 12, further comprising:
setting the first block of the user space to the first level cell mode;
setting a block of the hidden space to the first level cell mode; and
setting a second block of the user space to a second level cell mode, wherein the second block is configured to store the data.

20. A computer readable storage medium, having instructions stored thereon that, when executed, implement an operation method of a memory system, wherein the memory system comprises a memory and a memory controller coupled with the memory, and a physical space of the memory is divided into a user space and a hidden space;
wherein the operation method comprises:
setting a first block of the user space as a write booster buffer, wherein the first block is of a first level cell mode, and the write booster buffer is configured to buffer data; and
setting a free block of the hidden space as the write booster buffer, wherein the free block is of the first level cell mode.
